(19) United States
(12) Patent Application Publication
(10) Pub. No.: US 2026/0098998 A1
(43) Pub. Date: Apr. 9, 2026

(54) BUNDLED OPTICAL FIBER

(71) Applicant: NTT, Inc., Tokyo (JP)

(72) Inventors: Kazuhide NAKAJIMA, Musashino-shi, Tokyo (JP); Chisato FUKAI, Musashino-shi, Tokyo (JP); Takashi MATSUI, Musashino-shi, Tokyo (JP); Yuto SAGAE, Musashino-shi, Tokyo (JP); Katsuhisa TAGUCHI, Musashino-shi, Tokyo (JP); Ayako IWAKI, Musashino-shi (JP); Takahito KIRIHARA, Musashino-shi, Tokyo (JP); Satoshi NARIKAWA, Musashino-shi, Tokyo (JP)

(73) Assignee: NTT, Inc., Tokyo (JP)

(21) Appl. No.: 19/116,025

(22) PCT Filed: Oct. 5, 2022
(86) PCT No.: PCT/JP2022/037319

§ 371 Date: Mar. 27, 2025

(51) Int. Cl. G02B 6/04; G02B 6/42

(52) U.S. Cl. CPC G02B 6/04; G02B 6/4202

(57) ABSTRACT

An object of the present invention is to provide a bundle optical fiber that can improve the coupling efficiency of light from a light source, enable space division multiplexing transmission, and can be manufactured by a simple process.

A bundle optical fiber 301 according to the present invention is formed by bundling a plurality of single-core resin clad optical fibers 30 covering the outer periphery of a glass core 11 with a resin clad 15 having a refractive index smaller than that of the glass core 11. Only the core glass 11 is heated and drawn, and the resin clad 15 is applied to the outer periphery of the core glass 11 after drawing, to form a single-core resin clad optical fiber 30, and a plurality of single-core resin clad optical fibers 30 are bundled to form the bundle optical fiber 301.

### TECHNICAL FIELD

The present disclosure relates to a bundle optical fiber formed by bundling a plurality of optical fibers, and an optical transmission system and an optical communication system including the bundle optical fiber.

### BACKGROUND ART

Ultraviolet light is used, for example, for inactivation and cleaning of viruses. For example, NPL 1 discloses virus inactivation by an LED light source from which a wavelength harmful to a human body is removed, and NPL 2 discloses a cleaning technique using an excimer lamp.

Visible light is utilized in applications such as, for example, artificial light sources, communications, or image propagation in plant factories. For example, NPL 3 discloses a plant factory using light sources of various visible wavelength bands.

Infrared light is widely used in optical communications.

### CITATION LIST

### Non Patent Literature

[NPL 1] https://clean.ushio.com/jp/lp/car222-medical/?gclid=EAIaIQobChMIsa605bmY-QIV2qiWCh3FVARuEAAYASAAEgLKPfD_BwE, searched on Aug. 7, 2022

[NPL 2]

https://www.ushio.co.jp/jp/technology/lightedge/200810/100367. html, searched on Aug. 7, 2022

[NPL 3]

https://www.jstage.jst.go.jp/article/shita/22/1/22_1_2/_pdf, searched on Aug. 7, 2022

[NPL 4] https://www.fujikura.co.//products/optical/ opticalfibers/07/2051991_11310.html

[NPL 5] https://www.fujikura.co.jp/resource/pdf/100_05.pdf

[NPL 6] Yuto SAGAE, Takashi MATSUI, Taiji SAKAMOTO, Kazuhide NAKAJIMA, Ultra-Low Crosstalk Multi-Core Fiber with Standard 125-μm Cladding Diameter for 10,000 km-Class Long-Haul Transmission, IEICE Transactions on Communications, 2020, E103.B, Vol. 11, p.1199-1205

[NPL 7] T. Sakamoto et al., “Randomly-coupled single-mode 12-core fiber with highest core density,” 2017 Optical Fiber Communications Conference and Exhibition (OFC), 2017, pp. 1-3.

[NPL 8] T. Matsui, Y. Yamada, Y. Sagae, and K. Nakajima, “Standard cladding diameter multi-core fiber technology,” in Optical Fiber Communication Conference (OFC) 2021, P. Dong, J. Kani, C. Xie, R. Casellas, C. Cole, and M. Li, eds., OSA Technical Digest (Optica Publishing Group, 2021), paper Tu6B.4.

### SUMMARY OF INVENTION

### Technical Problem

Lamps and LEDs are generally used as ultraviolet light sources and visible light sources. The lamps and LEDS have a wide irradiation area and are suitable for irradiating a relatively wide range with one light source. However, such light sources have a problem that it is difficult to radiate light onto an environment or narrow area where installation of the light sources is difficult.

For this reason, in the case of radiating light onto an environment or narrow area where installation of the light sources is difficult, transmitting the light output from the light source to a desired area through an optical fiber and irradiating the desired area is considered. In this case, if the number of optical fibers is one, it is difficult for the light to enter the optical fiber from the light source, resulting in poor coupling efficiency.

Here, in the visible light region, an image fiber obtained by bundling a plurality of optical fibers, such as an endoscope, is widely used (see NPL 4, for example). By utilizing this, for example, a bundle optical fiber obtained by bundling optical fibers for ultraviolets or optical fibers for visible disclosed in NPL 5, the coupling efficiency of coupling an LED or lamp with the optical fiber in the wavelength region can be improved.

The bundle optical fiber is constituted by manufacturing a single-core optical fiber having a core and a clad and bundling a plurality of the single-core optical fibers.

Further, in order to manufacture the single-core optical fiber, it is necessary to prepare a glass material for forming the core and the clad, and to manufacture a base material for forming the optical fiber. Therefore, there is a problem that the manufacturing process is complicated and the cost is increased.

On the other hand, in general optical communications in an infrared region, the transmission capacity limit in the existing single-mode optical fiber is becoming a problem. For this reason, optical fiber technology for space division multiplexing transmission for multiplexing optical transmission paths in a limited space has been widely studied. For example, NPL 6 discloses a multi-core optical fiber technique where a plurality of cores included in one optical fiber can operate independently, and NPL 7 discloses an optical fiber technique for transmitting different optical signals (multi-modes) corresponding to the number of multiple cores by controlling optical wave coupling between adjacent cores.

However, in the optical fibers disclosed in these literatures, for example, one strand of glass base material is perforated, and a plurality of core materials are inserted into the perforated holes and integrated to produce an optical fiber base material. In other words, there is a problem that a complicated manufacturing process is required for a general multi-core optical fiber for optical communications in the infrared region.

In order to solve the foregoing problems, an object of the present invention is to provide a bundle optical fiber that can improve the coupling efficiency of light from a light source, enable space division multiplexing transmission, and can be manufactured by a simple process.

### Solution to Problem

In order to achieve the above object, in a bundle optical fiber according to the present invention, resins having a refractive index lower than that of cores made of single glass base material, such as ultraviolet curing resins, are each adhered to the cores, whereby single-core optical fibers are manufactured more easily, and the single-core optical fibers are bundled.

Specifically, the present invention is a bundle optical fiber including a plurality of single-core resin clad optical fibers bundled together, in which the single-core resin clad optical fibers cover outer peripheries of glass cores with a resin clad having a refractive index lower than that of the glass cores.

In the single-core resin clad optical fiber, a clad is formed of a resin. Therefore, only the glass core needs drawing from the single type of base material, and the base material including the clad and the core is not required, whereby the single-core resin clad optical fiber can be manufactured by a simple process. The coupling efficiency of light from the light source can be enhanced by bundling the single-core resin clad optical fibers up to approximately the spot size of the light source. Further, by adjusting the thickness of the resin clad, a multi-core optical fiber with optical coupling or a multi-core optical fiber with negligible optical coupling can be obtained.

Accordingly, the present invention can provide a bundle optical fiber that can improve the coupling efficiency of light from a light source, enable space division multiplexing transmission, and can be manufactured by a simple process.

The bundle optical fiber according to the present invention further includes a sheath that fills a gap between the single-core resin clad optical fibers, covers the plurality of single-core resin clad optical fibers, and has a desired value as a cross-sectional diameter thereof.

Here, a refractive index N1 of the glass core, a refractive index N2 of the resin clad, and a refractive index N3 of the sheath preferably satisfy the following relation: N2≤N3<N1.

An optical transmission system according to the present invention includes:
the bundle optical fiber; and
a light source making light incident on one end of the bundle optical fiber,
wherein an irradiation region of light from the light source at the one end of the bundle optical fiber includes all the glass cores appearing at the one end of the bundle optical fiber, or is located inside a circle inscribed with all the glass cores on an outermost periphery among the glass cores appearing at the one end of the bundle optical fiber.

Since each glass core can be efficiently irradiated with light from the light source, the coupling efficiency of the light from the light source can be enhanced.

An optical transmission system according to the present invention includes:
the bundle optical fiber; and
a plurality of light sources making light incident on each of the glass cores appearing at one end of the bundle optical fiber,
wherein space division multiplexing optical transmission may be performed by one of the bundle optical fiber by transmitting different optical signals for each of the glass cores.

An optical communication system according to the present invention includes the bundle optical fiber as a multi-core optical fiber with negligible optical coupling or a multi-core optical fiber with optical coupling.

The optical communication system enables space division multiplexing transmission.

The above inventions can be combined as much as possible.

### Advantageous Effects of Invention

The present invention can provide a bundle optical fiber that can improve the coupling efficiency of light from a light source, enable space division multiplexing transmission, and can be manufactured by a simple process.

### BRIEF DESCRIPTION OF DRAWINGS

FIG. 1 is a diagram for explaining a method for manufacturing a bundle optical fiber according to the prior art.

FIG. 2 is a diagram for explaining a bundle optical fiber according to the present invention.

FIG. 3 is a diagram illustrating an optical transmission system according to the present invention.

FIG. 4 is a diagram for explaining a bundle optical fiber according to the present invention.

FIG. 5 is a diagram for explaining a single-core resin clad optical fiber constituting the bundle optical fiber according to the present invention.

FIG. 6 is a diagram for explaining the bundle optical fiber according to the present invention.

FIG. 7 is a diagram for explaining the bundle optical fiber according to the present invention.

FIG. 8 is a diagram for explaining a single-core resin clad optical fiber constituting the bundle optical fiber according to the present invention.

FIG. 9 is a diagram for explaining the bundle optical fiber according to the present invention.

### DESCRIPTION OF EMBODIMENTS

Embodiments of the present invention will be described with reference to the accompanying drawings. The embodiments to be described below are examples of the present invention, and the present invention is not limited to the following embodiments. It is assumed that constituent elements with the same reference numerals in the present specification and the drawings represent the same constituent elements.

### Embodiment 1

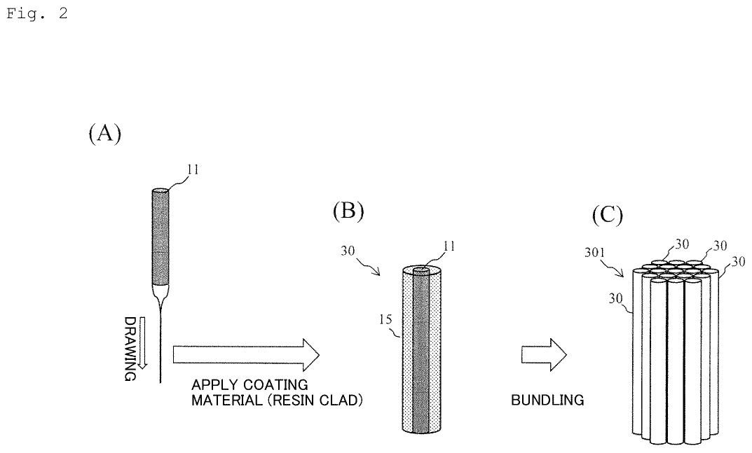

FIG. 2 is a manufacturing process diagram for explaining a bundle optical fiber 301 according to the present embodiment. The bundle optical fiber 301 is formed by bundling a plurality of single-core resin clad optical fibers 30 covering an outer periphery of a glass core 11 with a resin clad 15 having a refractive index lower than that of the glass core 11.

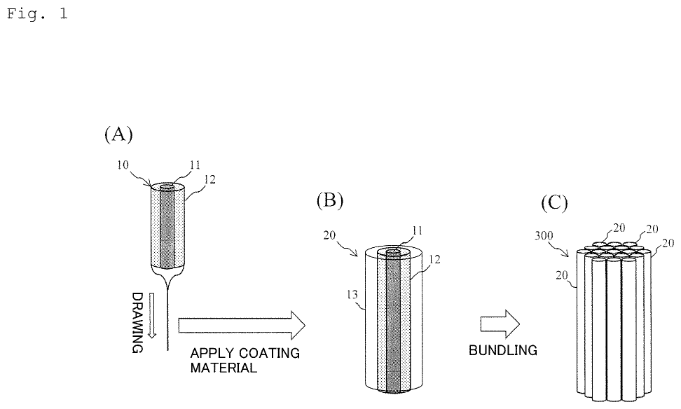

FIG. 1 is a manufacturing process diagram for explaining a conventional bundle optical fiber 300 which is a comparative example. It is necessary to prepare a base material 10 in which the periphery of the core glass 11 is covered with a clad glass 12 (FIG. 1(A)). The base material 10 is heated and drawn, and a coating material 13 is applied to the outer periphery of the clad glass 12, to form a single-core optical fiber 20 (FIG. 1(B)). Then, a plurality of the optical fibers 20 are bundled to form the bundle optical fiber 300 (FIG. 1(C)).

On the other hand, as to the bundle optical fiber 301, the base material 10 such as the one shown in FIG. 1(A) is not required. Only the core glass 11 is heated and drawn (FIG. 2(A)), and the resin clad 15 is applied to the outer periphery of the core glass 11 after drawing, to generate the single-core resin clad optical fiber 30 (FIG. 2(B)). Then, a plurality of the single-core resin clad optical fibers 30 are bundled to form the bundle optical fiber 301 (FIG. 2(C)).

Thus, the bundle optical fiber 301 does not need to prepare the base material 10, and can be generated by a simple process of applying the resin clad 15 to the core glass 11 after drawing.

### Embodiment 2

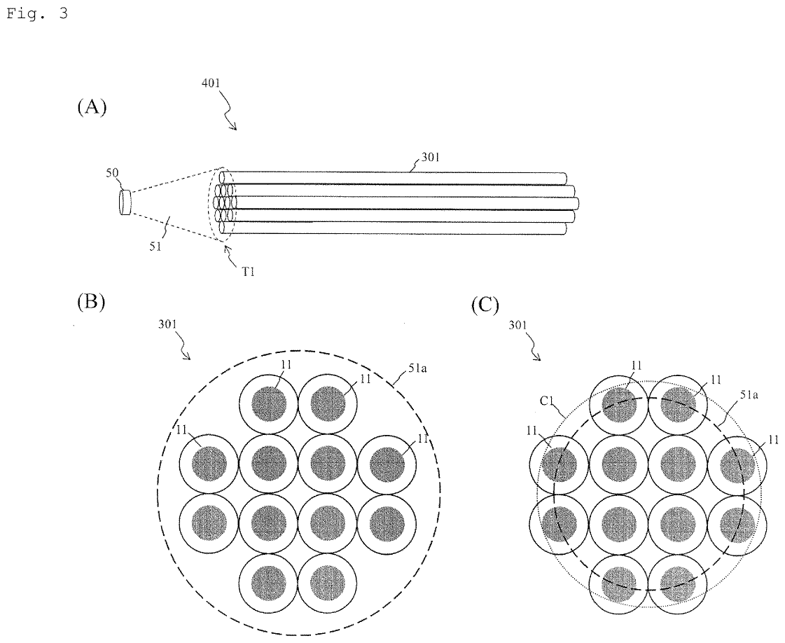

FIG. 3 is a diagram for explaining an optical transmission system 401 for transmitting light 51 (infrared light, visible light, ultraviolet light, etc.) from a light source 50 to a distant place by using the bundle optical fiber 301. The light source 50 is, for example, a lamp, an LED light source, a single-mode LD, or a multi-mode LD.

The optical transmission system 401 includes the bundle optical fiber 301 and the light source 50 for emitting the light 51 incident on one end T1 of the bundle optical fiber 301, and is configured such that all or most of the glass cores 11 appearing at the one end T1 of the bundle optical fiber 301 are contained within an irradiation region of the light 51 from the light source 50 beside the one end T1 of the bundle optical fiber 301.

Here, FIG. 3(B) is a diagram for illustrating the former: all the glass cores 11 appearing at the one end T1 of the bundle optical fiber 301 are contained within an irradiation region 51a of the light 51 from the light source 50 beside the one end T1 of the bundle optical fiber 301.

On the other hand, FIG. 3 (C) is a diagram for illustrating the latter: most of the glass cores 11 appearing at the one end T1 of the bundle optical fiber 301 are contained within the irradiation region 51a of the light 51. That is, FIG. 3(C) is a diagram for illustrating a situation where the irradiation region 51a of the light 51 from the light source 50 beside the one end T1 of the bundle optical fiber 301 is located inside a circle C1 internally touching all the outermost, or most peripheral, glass cores 11 out of the glass cores 11 appearing at the one end T1 of the bundle optical fiber 301.

The term “most are included” applies to the case where a bundle surface is wider than the irradiation region 51a, and refers to the situation where the light 51 does not enter some of the glass cores 11 or only part of the light 51 enters some of the glass cores 11.

In order to couple the light 51 from the light source 50 to the bundle optical fiber 301, it is preferable that a numerical aperture (NA) of the single-core resin clad optical fiber 30 be relatively large. Here, the NA of the single-core resin clad optical fiber 30 can be regulated by the following equation from the refractive index N1 of the core glass 11 and the refractive index of the resin clad 15.

$$NA = {( N {1}^{2} - N {2}^{2} )}^{0.5}$$

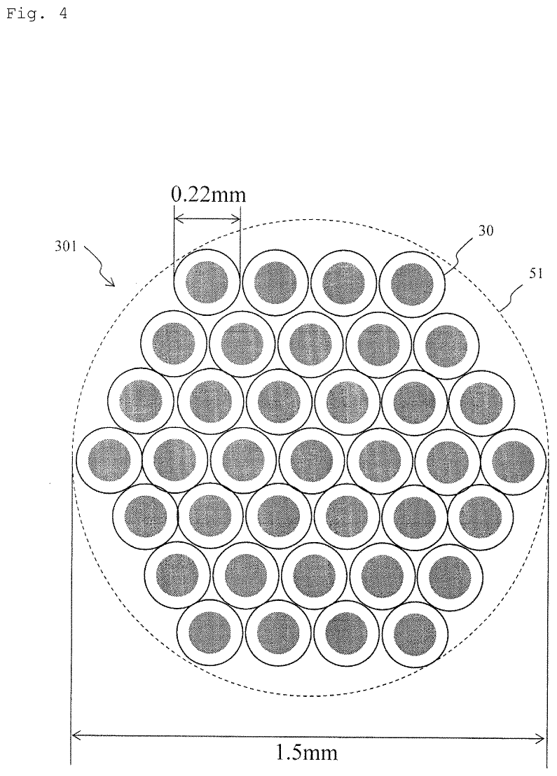

FIG. 4 is a diagram in which the one end T1 of the bundle optical fiber 301 is viewed from an axial direction of the bundle optical fiber 301. In this example, the NA of the single-core resin clad optical fiber 30 is 0.22, and the core radius thereof is 100 μm. The thickness of the resin clad 15 may be approximately several tens um or more, and in this example, the thickness is set to 10 μm. Although the core radius can be set to any value, it is preferable that the core radius be equal to or less than approximately 150 μm because the rigidity of the glass becomes high and the flexibility thereof becomes impaired if the core radius is too large.

As the light source 50, this example takes an LED in an ultraviolet wavelength region with the spot diameter of the light 51 at the one end T1 of the bundle optical fiber 301 is approximately 1.5 mm. For the sake of realization of the coupling the ultraviolet light into the bundle optical fiber 301, thirty-seven single-core resin clad optical fibers 30, each of which has an outer diameter of the resin clad 15 set to 220 μm, were bundled in a hexagonal close-packed manner. Thus, the maximum diameter after bundling can be set to approximately 1.5 mm. The number of bundles is not limited, and the fibers can be bundled in an arbitrary shape. It is preferable that the cross-sectional shape of the bundle optical fiber 301 be similar to that of the light emitting surface of the light source 50, as described in the present example.

The light intensity measured directly by a light receiving element having a light receiving surface larger than the LED light emitting surface at the emission end of the LED, which is the light source 50, was approximately 1.7 mW. As a comparative example, the light from the LED was propagated along a 1 m length of (exactly) one conventional single-core glass clad optical fiber. The light intensity of the light emitted from the optical fiber was measured by a light receiving element and was approximately 17 μW. Therefore, the coupling efficiency with respect to the optical fiber is approximately 1%. On the other hand, the light from the LED was propagated along a 1 m length of the bundle optical fiber 301, and the light intensity of the emitted light measured by the light receiving element was approximately 1.7 mW. Thus, it has been found that the coupling efficiency of approximately 100% can be obtained by bundling the optical fibers.

Since the light from the light source spreads to some extent, one optical fiber, as in the comparative example, causes most of the light to fail of coupling to the core glass of the optical fiber. On the other hand, as in the present embodiment, by a bundle of multiple optical fibers that has a thickness comparable to the diameter of the spread light, even the light that cannot be received by one optical fiber can be received, and the coupling efficiency improves.

However, as shown in FIG. 3(C), the cores of the outer peripheral optical fibers located outside the spot diameter (the diameter of the bundle optical fiber is larger) bring about the coupling efficiency reaching approximately 100%, but are overdesigned or overengineered due to occurrence of an optical fiber on which light is not incident (useless optical fiber). On the other hand, as shown in FIG. 3(B), the cores of the outer peripheral optical fibers located inside the spot diameter (the diameter of the bundle optical fiber is smaller) do not bring about any optical fibers on which light is not incident (useless optical fibers), but cause reduction in coupling efficiency due to increase in light coupled into no optical fibers. As described above, the number of bundled optical fibers is determined, in consideration of the coupling efficiency and the overdesign or overengineering, on the basis of the spot diameter of the spread light 51 as shown in FIG. 3(B) and 3(C).

### Embodiment 3

The optical communication system of the present embodiment includes the bundle optical fiber 301, and a plurality of light sources for emitting light incident on each glass core 11 appearing at one end T1 of the bundle optical fiber 301, and is characterized in that different optical signals are transmitted through separate glass cores 11, and space division multiplexing optical transmission is performed through one bundle optical fiber 301.

The present embodiment will describe an example of using the bundle optical fiber 301 as a multi-core optical fiber with negligible optical coupling.

In general, a single-mode single-core optical fiber is used in a large-capacity optical communication system utilizing an infrared wavelength region. The present example will describe a multi-core optical fiber with negligible optical coupling in which single-core resin clad optical fibers 30 in a single mode are bundled will be described.

In the single-core resin clad optical fiber 30 of the present example, in order to realize a favorable single-mode operation with a communication wavelength band having a range of wavelengths from 1260 to 1625 nm, the core glass 11 is made of pure silica glass having a diameter set to approximately 9 μm, and the relative index difference between the resin clad 15 and the core glass 11 is set to approximately 0.35%. Note that the optical characteristics of the single-mode optical fiber for communication are standardized by ITU-T Recommendation G. 65x (x=2, 3, 4, 5, 6, 7), and preferably designed to be optical characteristics equivalent to that of the concerned optical fiber thereof.

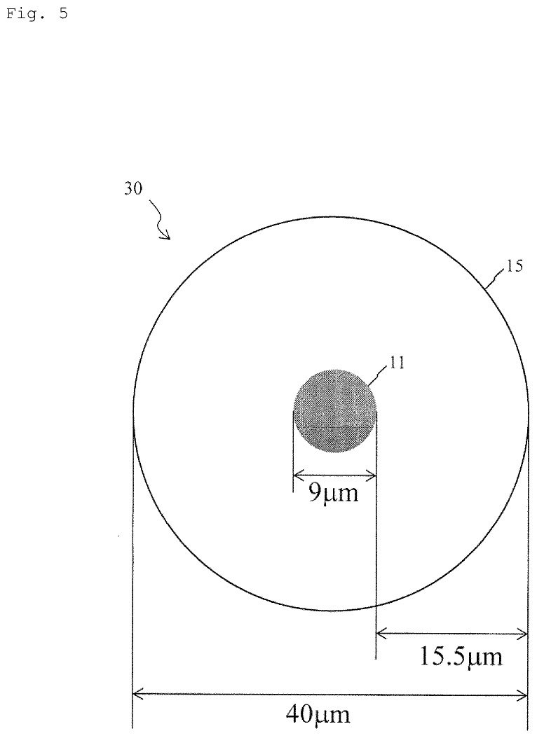

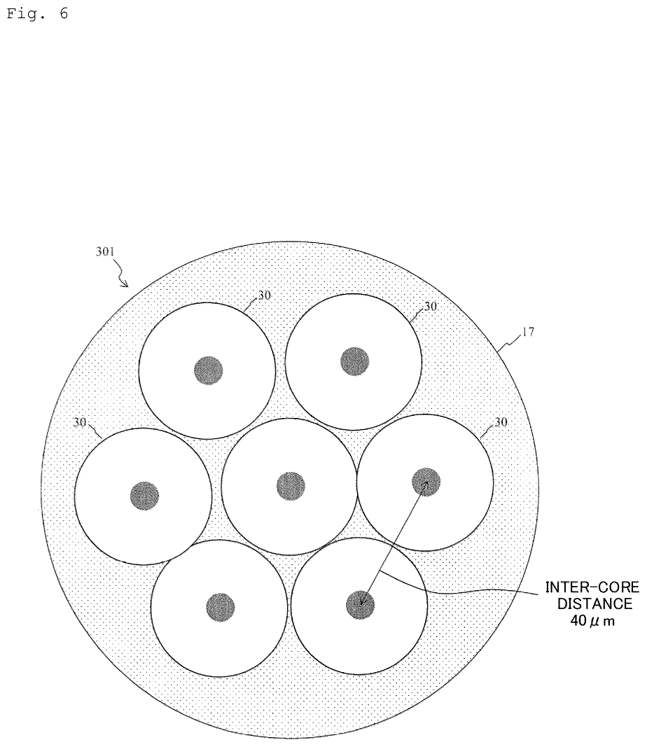

Here, in order to operate each core independently, it is necessary that the distance between adjacent cores is sufficiently large when the cores are bundled. Generally, it is known that the distance between adjacent cores set to approximately 40 μm can sufficiently reduce crosstalk caused by the optical wave coupling between cores (see NPL 8, for example); in the present example, the thickness of the resin clad 15 is set to approximately 15.5 μm, and the minimum distance between adjacent cores (the distance between the centers of the core glasses 11) is set to 40 μm or more (see FIGS. 5 and 6).

In the present example, as shown in FIG. 6, seven single-core resin clad optical fibers 30 are bundled in a hexagonal close-packed state to realize a seven-core multi-core optical fiber with negligible optical coupling. The number and shape of the optical fibers to be bundled can be arbitrarily set.

Here, the entire bundled optical fibers are covered with an outer resin coating 17, so that they can be handled integrally. That is, the bundle optical fiber 301 of the present embodiment is characterized in including a sheath (outer resin coating 17) that fills a gap between the single-core resin clad optical fibers 30, covers the plurality of single-core resin clad optical fibers 30, and has a desired value as a cross-sectional diameter thereof.

The outer resin coating 17 is, for example, a refractive index matching gel or an ultraviolet curing resin.

From the perspective of preventing leakage light from being re-coupled to the core glass 11 and retaining the propagation characteristics of the core glass 11, the refractive index N3 of the outer resin coating 17 is preferably equal to or higher than the refractive index N2 of the resin clad 15 and less than the refractive index N1 of the core glass 11.

$$N 2 \leq N 3 < N 1$$

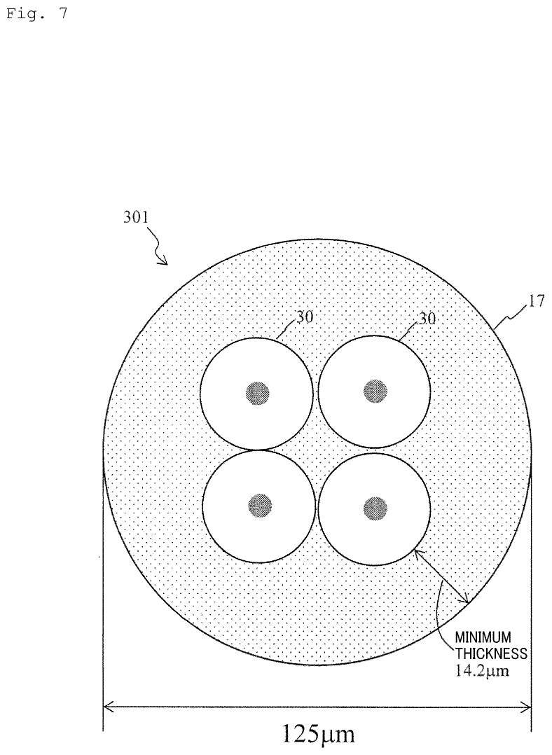

In typical optical fibers for communications, since the standardized cladding diameter of the optical fibers is 125 μm, the multi-core optical fiber with negligible optical coupling (bundle optical fiber 301) of the present embodiment also preferably have the same diameter, which allow continued use of the existing optical connector technique or optical cabling technique. For example, as shown in FIG. 7, while single-core resin clad optical fibers 30 having a diameter set to approximately 40 μm are bundled in a square lattice shape with their whole bundle shape helical, the outer resin coating 17 is filled up so that the minimum thickness thereof in the diagonal optical fiber direction is approximately 14.2 μm.

The bundle optical fiber 301 shown in FIG. 7 can be used as a 4-core multi-core optical fiber with negligible optical coupling having an outer diameter of 125 μm.

### Embodiment 4

The optical communication system of the present embodiment includes the bundle optical fiber 301, and a plurality of light sources for emitting light incident on each glass core 11 appearing at one end T1 of the bundle optical fiber 301, and is characterized in that different optical signals are transmitted through separate glass cores 11, and space division multiplexing optical transmission is performed through one bundle optical fiber 301.

The present embodiment will describe an example of using the bundle optical fiber 301 as a multi-core optical fiber with optical coupling.

In general, a single-mode single-core optical fiber is used in a large-capacity optical communication system utilizing an infrared wavelength region. The present example will describe a multi-core optical fiber with optical coupling in which single-core resin clad optical fibers 30 in a single mode are bundled.

In the single-core resin clad optical fiber 30 of the present example, in order to realize a favorable single-mode operation with a communication wavelength band having a range of wavelengths from 1260 to 1625 nm, the core glass 11 is made of pure silica glass having a diameter set to approximately 9 μm, and the relative index difference between the resin clad 15 and the core glass 11 is set to approximately 0.35%.

Here, by setting appropriate optical wave coupling between adjacent cores, optical signals for the number of multiplexed cores can be guided. The appropriate optical wave coupling can be controlled by the distance between adjacent cores. In a case where a general-purpose single-mode core is used, it is known that the appropriate optical wave coupling can be realized by setting the core interval to 15 to 25 μm. For example, NPL 7 discloses that favorable 12-mode propagation can be performed by arranging twelve cores in a square lattice shape so as to have a core interval of 16.4 μm.

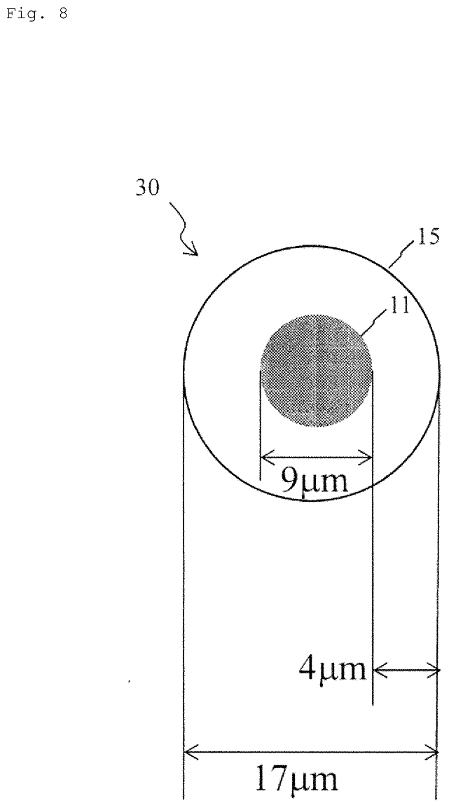

In the present example, as shown in FIG. 8, germanium-doped core glass 11 having a diameter of approximately 9 μm was covered with the resin clad 15 having a thickness of approximately 4 μm, to produce a single-core resin clad optical fiber 30 having a diameter of approximately 17 μm.

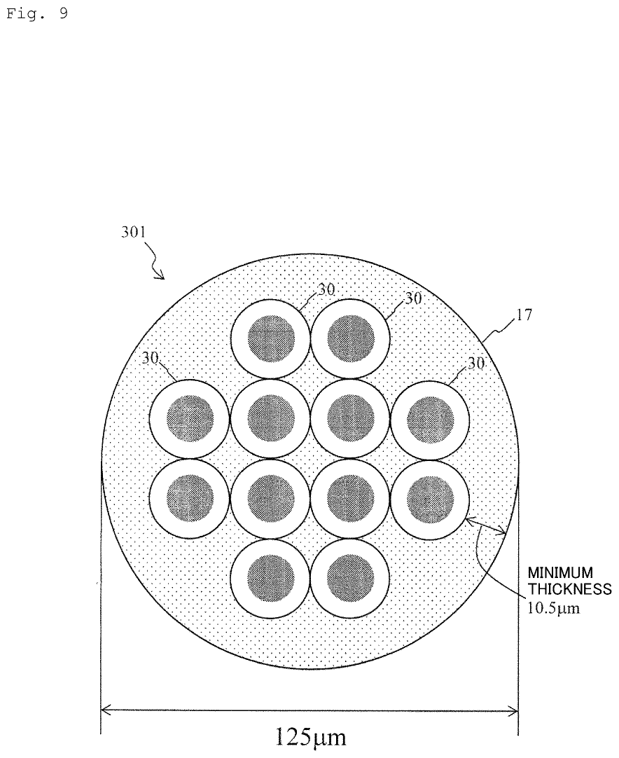

Then, as shown in FIG. 9, twelve single-core resin clad optical fibers 30 were bundled in a square lattice shape to produce a 12-core multi-core optical fiber with optical coupling (bundle optical fiber 301). Further, the outer resin coating 17 is set so that the minimum thickness thereof in the

Radial direction of the bundle optical fiber 301 is approximately 10.5 μm. Here, the refractive index N3 of the outer resin coating 17 can be set to any amount, but is preferably equal to the refractive index N2 of the resin clad 15, so that stable inter-core coupling can be retained in the longitudinal direction.

The refractive index of the core glass 11: N1

The refractive index of the resin clad 15: N2

### Effects of Invention

The bundle optical fiber 301 described in the present embodiment has the following advantageous effects.

(Advantage 1) Simplification of manufacturing process Since it is not necessary to constitute the clad part with a glass material in manufacturing the optical fiber, the optical fiber base material can be manufactured with a single glass material having a uniform refractive index.

(Advantage 2) Simplification of manufacturing process By bundling the individual single-core resin clad optical fibers 30, the multi-core optical fiber can be manufactured without performing the special base material processing described above.

(Advantage 3) Space division multiplexing transmission in which optical wave coupling between cores is suppressed can be performed

By adjusting the deviation between the refractive index N1 of the core glass 11 and the refractive index N2 of the resin clad 15, and the thickness of the resin clad 15, the amount of penetration of propagation light into the outside of the clad region of each optical fiber is controlled, so that the amount of optical wave coupling between adjacent bundle optical fibers (cores) can be controlled. By filling a gap, generated in a cross-sectional space of the bundle optical fiber, with the outer resin coating 17 having a desired refractive index N3, the light penetrated into the outside of the clad region is prevented from being re-coupled into the core glass 11, the propagation characteristics of the core glass 11 can be retained, and large-capacity optical communication transmission can be performed as space division multiplexing transmission through a multi-core fiber with negligible optical coupling.

(Advantage 4) Space division multiplexing transmission utilizing inter-core optical wave coupling is possible By adjusting the deviation between the refractive index N1 of the core glass 11 and the refractive index N2 of the resin clad 15, and the thickness of the resin clad 15, and by filling a gap, generated in a cross-sectional space of the bundle optical fiber, with the outer resin coating 17 having a desired refractive index N3, the amount of optical wave coupling between adjacent optical fibers (cores) can be controlled, and large capacity optical communication transmission can be attained as space division multiplexing transmission through a multi-core fiber with optical coupling.

### Reference Signs List

11 Core glass
12 Clad glass
13 Coating material
15 Resin clad
17 Outer resin coating
20 Optical fiber
30 Single-core resin clad optical fiber
50 Light source
51 Light
51a Irradiation region
300, 301 Bundle optical fiber
401 Optical transmission system

1. A bundle optical fiber comprising a plurality of single-core resin clad optical fibers bundled together, the single-core resin clad optical fibers covering outer peripheries of glass cores with a resin clad having a refractive index smaller than that of the glass cores.

2. The bundle optical fiber according to claim 1, further comprising a sheath that fills a gap between the single-core resin clad optical fibers, covers the plurality of single-core resin clad optical fibers, and has a desired value as a cross-sectional diameter thereof.

3. The bundle optical fiber according to claim 2, wherein a refractive index N1 of the glass core, a refractive index N2 of the resin clad, and a refractive index N3 of the sheath satisfy the following relation:
$$N 2 \leq N 3 < N 1.$$

4. An optical transmission system, comprising:
a bundle optical fiber according to claim 1; and
a light source making light incident on one end of the bundle optical fiber,
wherein an irradiation region of light from the light source at the one end of the bundle optical fiber includes all the glass cores appearing at the one end of the bundle optical fiber, or is located inside a circle inscribed with all the glass cores on an outermost periphery among the glass cores appearing at the one end of the bundle optical fiber.

5. An optical transmission system, comprising:
a bundle optical fiber according to claim 1; and
a plurality of light sources making light incident on each of the glass cores appearing at one end of the bundle optical fiber,
wherein space division multiplexing optical transmission is performed by one of the bundle optical fiber by transmitting different optical signals for each of the glass cores.

6. An optical communication system comprising the bundle optical fiber according to claim 1 as a multi-core optical fiber with negligible optical coupling.

7. An optical communication system comprising the bundle optical fiber according claim 1 as a multi-core optical fiber with optical coupling.
